(19) United States
(12) Patent Application Publication
(10) Pub. No.: US 2005/0008047 A1
(43) Pub. Date: Jan. 13, 2005

(54) Laser system and laser wavelength conversion

(76) Inventors: Sonhi Hashimoto, Tokyo (JP); Toshifumi Tone, Tokyo (JP); Satoru Amano, Tokyo (JP)

Correspondence Address: DELLETT AND WALTERS, P. O. BOX 2786, PORTLAND, OR, 97208-2786, US

(21) Appl. No.: 10/819,087

(22) Filed: Apr. 5, 2004

(30) Foreign Application Priority Data
Apr. 11, 2003 (JP) 2003-107778

(51) Int. Cl. H01S 3/10

(52) U.S. Cl. 372/22; 372/21

(57) ABSTRACT

A laser system is enabled to generate laser beam stably for a long term by avoiding the decay of nonlinear optical crystals due to moisture. The fundamental laser wave at a wavelength of 1064 nm is emitted from the pumping chamber unit of the solid-state laser device. The fundamental laser wave enters the first nonlinear optical crystal unit (20). The wavelength of the laser beam is converted into a half by the first nonlinear optical crystal unit (20). The converted laser beam emanates out of the unit. The fundamental laser wave and the second harmonic laser wave are introduced into the second nonlinear optical crystal unit. Each of the laser beams is converted into the third harmonic laser wave (three-time fundamental frequency) or the fourth harmonic laser beam (four-time fundamental frequency) and the laser beam comes out of the exit-window (34). The nonlinear optical crystal units (20), (30) are held in a hermetically sealed cell whose inner surface is treated to be water-repellent. As the dry atmosphere is kept by means of isolating the nonlinear optical crystal from the outer air, the crystals can avoid decay due to moisture and the damage on the crystals can be reduced.

### BACKGROUND OF THE INVENTION

1. Field of the Invention

This invention relates to a laser system and a laser wavelength conversion system, especially to such systems that the maintenance of those nonlinear optical crystals to convert wavelength is made easy.

2. Prior Art

Generally, in a shortwave laser system, wavelength is converted by nonlinear optical crystal. General composition of an ultraviolet solid-state laser system, which is one of shortwave laser systems, is as follows. Wavelength of fundamental laser wave generated by Nd:YAG laser, Nd:YVO₄ laser, Nd:YLF laser and so on is 1064 nm. The second harmonic is generated by nonlinear optical crystal. Moreover, the third or fourth harmonic is generated. LBO crystal or KTP crystal is employed to generate the second harmonic. LBO crystal, BBO crystal or GdYCOB crystal is employed to generate the third harmonic. BBO crystal, CLBO crystal or the like is employed to generate the fourth harmonic.

Almost all of these nonlinear optical crystals are deliquescent. Therefore, in the long term operation of the laser system, the crystals are decayed with absorption of moisture. Accordingly, the power of the harmonic laser wave gets decreased. Nevertheless, no particular regard is paid to the humidity in the resonator as shown in the patent document JP05-152656A, even though KTP crystal is employed as the nonlinear optical crystal to generate the second harmonic and BBO crystal is employed as the nonlinear optical crystal to generate the third harmonic.

The nonlinear optical crystal CLBO to generate the fourth harmonic is decayed rapidly at relative humidity of more than 30%. As the prevention against it, in the commercial crystal cell of Model No. 10031 of Crystal Associated Inc., dry gas is enclosed and sealed in the cell. But, even though a little, water molecules are adhesive on the surface of the inner wall of the cell. Therefore, the water molecules leaving off the surface of the inner wall of the cell are absorbed in the nonlinear optical crystal and give rise to hydroxyl radicals (—OH) on the surface of the crystal. When the laser system is operated, the hydroxyl radicals absorb the fourth harmonic laser wave and grow impurities. The impurities reduce the transparency of the crystal for the fourth harmonic laser wave. Accordingly, the power of the laser beam decreases. Such phenomenon arises on the nonlinear optical crystals for the second or third harmonic laser wave generation.

That is, there is a problem that the decay of the nonlinear optical crystals due to moisture for a long term operation cannot be prevented with the conventional method to avoid moisture. In the case that dry gas is only sealed in the crystal cell, there is no means ready to remove the moisture on the inner wall of the cell. Also there is no means to recover any defect occurred on the sealing structures of the cell. There is no regard to the decay of nonlinear optical crystals due to moisture for a long term operation. After continuous operation of the laser system without any means to avoid moisture in the cell, the nonlinear optical crystal with captured moisture absorbs the fourth harmonic laser wave and creates impurities. Thus the transparency for the fourth harmonic laser wave is getting worse. Therefore, the wavelength conversion efficiency falls down rapidly and the output power of the laser beam is reduced to a very small extent.

### SUMMARY OF THE INVENTION

The object of this invention is to enable a laser system to generate laser beam stably for a long term by purging moisture from the cell of nonlinear optical crystals. In order to solve the above problem, the laser system of the present invention is arranged as follows. The laser system employing nonlinear optical crystal to generate harmonics of fundamental laser wave out of a laser light source includes a sealed cell provided with a through-chamber of path of the laser wave and a window to cover the through-chamber, wherein the nonlinear optical crystal is disposed in the cell and the inner surface of the cell is treated to be water-repellent.

As arranged above, the laser system can generate laser beam stably for a long term. The nonlinear optical crystal is held in the hermetically sealed vessel (nonlinear optical crystal cell). The inner wall of the hermetically sealed vessel is covered with water-repellent coating. Dry inert gas (Ar, N₂, etc.) is filled in the sealed vessel. In this way, the decay of the nonlinear optical crystal due to moisture can be prevented even for a long term operation.

### BRIEF DESCRIPTION OF THE DRAWINGS

FIG. 1 shows the schematic side view of the laser system according to the embodiment of this invention.

FIG. 2 shows the schematic plan view of the second harmonic laser system of intra-chamber type according to the embodiment of this invention.

FIG. 3 shows the schematic plan view of the third and fourth harmonic laser system of intra-chamber type according to the embodiment of this invention.

FIG. 4 shows the schematic cross section of the nonlinear optical crystal cell employed in the laser system according to the embodiment of this invention.

FIG. 5 shows the partially enlarged figure of the nonlinear optical crystal cell employed in the laser system according to the embodiment of this invention.

FIG. 6 shows the schematic cross section of the lid of the nonlinear optical crystal cell employed in the laser system according to the embodiment of this invention.

FIG. 7 show the schematic block diagram of the humidity measuring means employed in the laser system according to the embodiment of this invention.

FIG. 8 shows the graph showing the time trend of the humidity in the nonlinear optical crystal cell employed in the laser system according to the embodiment of this invention.

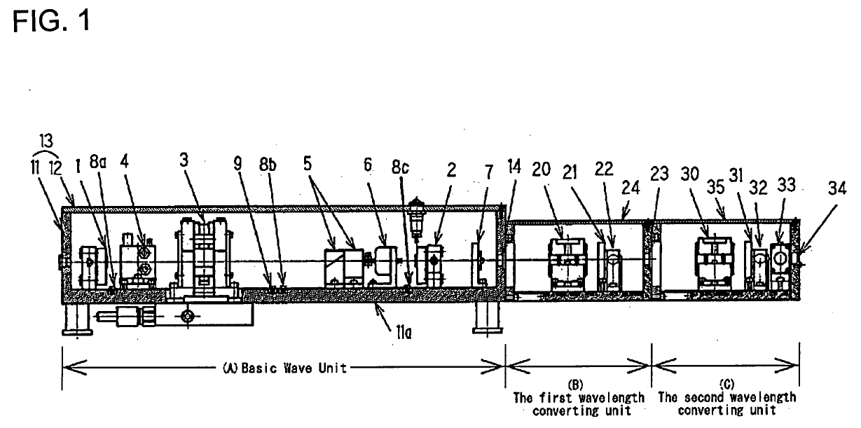

In FIGS. 1 to 8, reference numbers depict as follows. 1 or 2 is the mirror of basic laser resonator. 3 is a pumping chamber unit. 4 is a Q-switch. 5 is a Brewster plate. 6 is a shutter. 7 is the first condenser lens. 8a, 8b, 8c or 8d is a heater. 9 is a temperature sensor. 10 is a resonant mirror. 11 is the case of the basic unit. 12 is the lid of the basic unit. 13 is the vessel of the basic unit. 20 is the first nonlinear optical crystal unit. 21 is the second condenser lens. 22 is the separating mirror to separate the fundamental wave and the second harmonic wave. 23 is the exit-window of the second harmonic wave. 24 is the first wavelength conversion unit case. 30 is the second nonlinear optical crystal unit. 31 is a collimate lens. 32 is the separating mirror to separate the second harmonic and the fourth harmonic. 33 is the power meter of the third or the fourth harmonics. 34 is the exit-window of the third or the fourth harmonics. 35 is the second wavelength conversion unit case. 40 is the cell body of the nonlinear optical crystal cell. 41 is the stage for nonlinear optical crystal. 42 is a through-chamber. 43 is a nonlinear optical crystal. 44 is the crystal cramp of the nonlinear optical crystal. 45 is a heater. 46 is the orifice of the cell body. 50 is the cell lid of the nonlinear optical crystal cell. 51 is a humidity sensor. 52 is a hermetic seal terminal. 53 is a humidity sensing circuit board. 54 is the concave of the cell lid. 55 is a humidity sensing amplifier. 56 is a hygrometer. 57 is a switch. 58 is a laser controller. 60a or 60b is the window of the nonlinear optical crystal cell. 70a or 70b is the window clamp of the nonlinear optical crystal cell. 80a, 80b, 80c, 80d or 80e is an O-ring. 90a or 90b is a water-repellent coating.

### DETAIL DESCRIPTION OF THE PREFERRED EMBODIMENTS

Preferred embodiments of this invention are described in detail referring to FIGS. 1 to 8 hereinafter. The embodiment of this invention is the solid-state laser system that the nonlinear optical crystal is held in the hermetically sealed vessel in which dry inert gas is filled and whose inner wall is covered with water-repellent coating.

FIG. 1 shows the outline of the solid-state laser system according to the first embodiment of this invention. A solid-state laser device, i.e. a laser diode, is employed as the laser light source. This solid-state laser system is the wavelength converting laser system. It is composed of a basic unit (A), the first wavelength converting unit (B) and the third wavelength converting unit (C).

The basic unit (A) includes the mirror (1) of the basic optical unit, a mirror (2), a pumping chamber unit (3), a Q-switch (4), a Brewster plate (5), a shutter (6), the first condenser lens (7) and so on. The mirror (1) and the mirror (2) constitute a laser resonator. The pumping chamber unit (3) is provided with solid-state laser material. The solid-state laser material is either one of Nd:YAG, Nd:YVO₄, Nd:YLF and so on and is excited by a semiconductor laser diode.

The basic unit (A) is also provided with vessel (13). The vessel (13) is composed of a case (11) and a lid (12). The case (11) has a window (14) for passing out the fundamental laser wave. The cross section of the case is U-shaped. The case holds the component parts to constitute the fundamental optical unit. The lid (12) covers hermetically the upper surface of the case (11). The inside of this case is filled with inert gas such as nitrogen gas or the like. On the bottom (11a) of the case (11), there are embedded several heaters (8a), (8b), (8c) and so on as many as necessary. The temperature sensor (9) to monitor the temperature in the vessel (13) is equipped near the pumping chamber unit (3). The temperature in the vessel is maintained at required temperature under the control of the temperature of the heaters (8a), (8b), (8c) and so on through the temperature regulator (not shown) according to the output of that sensor.

The first wavelength converting unit (B) is composed of the first nonlinear optical crystal unit (20), the second condenser lens (21) and the separating mirror-(22). These optical components=are held in the first wavelength converting unit case (24) provided with the exit-window (23). The first nonlinear optical crystal unit (20) holds LBO crystal or KTP crystal inside. LBO crystal or KTP crystal converts the fundamental laser wave converged by the condenser lens through the window (14) into the second harmonic wave of twice fundamental frequency. The separating mirror (22) separates the laser light into the fundamental wave and the second harmonic wave.

The second wavelength converting unit (C) is composed of the second nonlinear optical crystal unit (30), a collimate lens (31), a separating mirror (32) and the third or the fourth harmonic power meter (33). The second nonlinear optical crystal unit (30) converts the laser wave of twice fundamental frequency out of the first wavelength converting unit (B) into the third harmonic laser wave of three-time fundamental frequency or the fourth harmonic laser wave of four-time fundamental frequency. The separating mirror (32) separates the laser light into the second harmonic laser wave and the third (or the fourth) harmonic laser wave. LBO crystal, BBO crystal or GdYCOB crystal can be employed as the nonlinear optical crystal for the generation of the third harmonic. BBO crystal or CLOB crystal can be employed as the nonlinear optical crystal for the generation of the fourth harmonic. The optical components such as the second nonlinear optical crystal unit (30), the collimate lens (31), the separating mirror (32) to separate the second harmonic from the third (or the fourth) harmonic, the fourth harmonic power meter (33) and so on are held in the second wavelength converting unit case (35) provided with the exit-window (34).

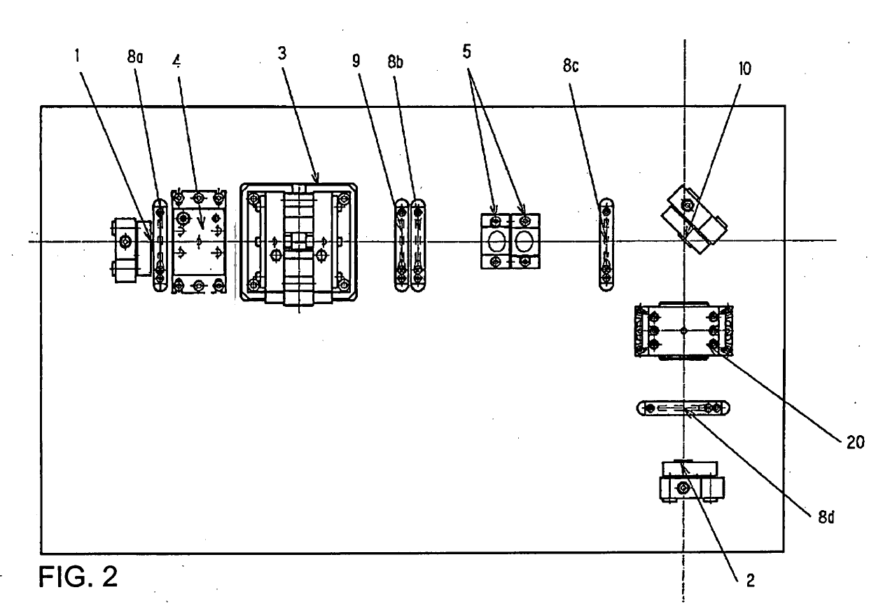

FIG. 2 shows the outline of the second harmonics laser system of the intra-chamber type according to the second embodiment of the solid-state laser system of this invention. A solid-state laser device is used as the laser light source in this system. This system is the second harmonics laser system of intra-chamber type that includes the first nonlinear optical crystal unit (20) to convert the laser wave into the second harmonic of twice fundamental frequency and the heater (8d) in the laser resonator.

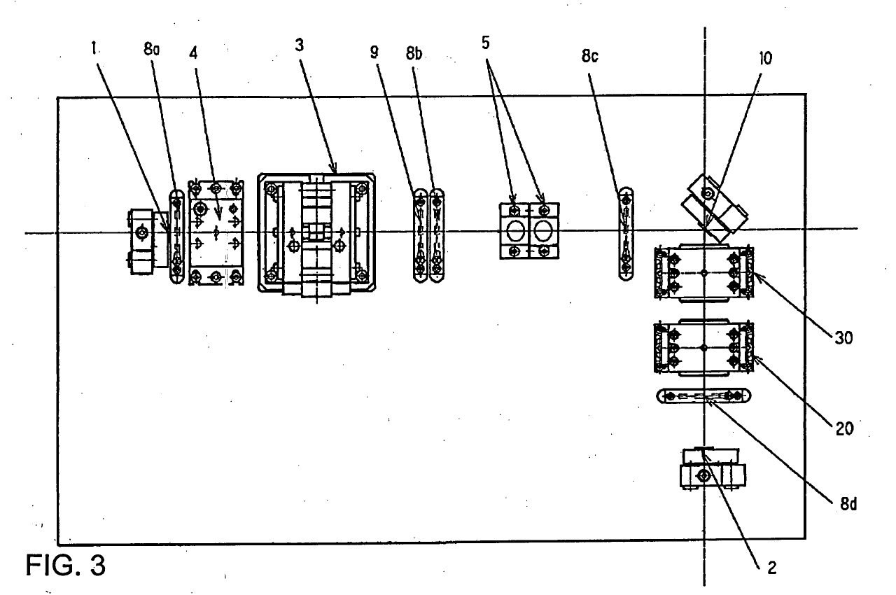

FIG. 3 shows the outline of the third and the fourth harmonics laser system of the intra-chamber type according to the third embodiment of the solid-state laser system of this invention. A solid-state laser device is used as the laser light source. The first nonlinear optical crystal unit (20) and the second nonlinear optical crystal unit (30) to convert the laser wave into the third harmonic of three-time fundamental frequency or the fourth harmonic of four-time fundamental frequency are held in the laser resonator. As each optical component is the same as shown in FIG. 1, detail description is eliminated.

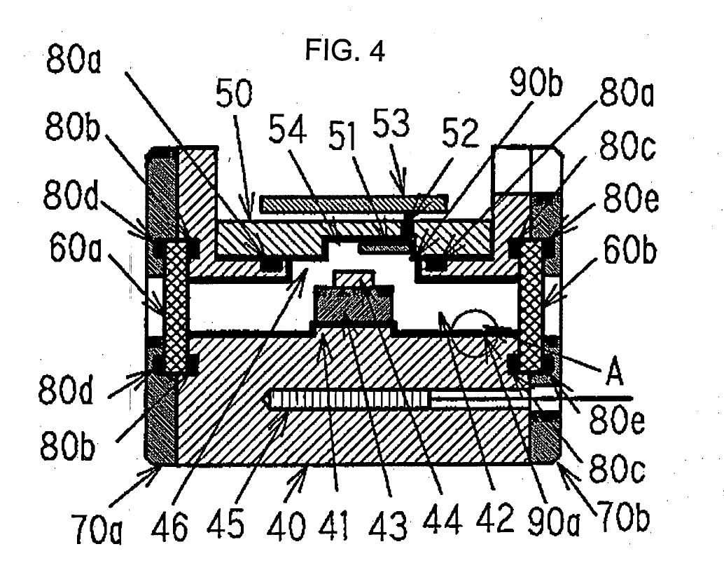

FIG. 4 shows the schematic cross section of the nonlinear optical crystal cell employed in the solid-state laser system according to the embodiment of this invention. This cell is employed in the first nonlinear optical crystal unit (20) or the second nonlinear optical crystal unit (30) as shown in FIGS. 1, 2 and 3. The first and the second nonlinear optical crystal units are generally called simply nonlinear optical crystal unit (NLU) hereinafter. The nonlinear optical crystal unit (NLU) is composed of a cell body (40) and a cell lid (50). The cell body (40) is the cell that the horizontal through-chamber (42) for the path of laser beam is formed therein and the cross section of the cell is U-shaped. The cell lid (50) is the lid that covers the orifice (46) of the cell body (40) with hermetic seal. The stage (41) is built in the center of the cell body (40) where the through-chamber (42) is formed. The nonlinear optical crystal (43) for generating harmonics is disposed on this stage (41). The nonlinear optical crystal (43) is fixed to the cell body (40) by the crystal clamp (44).

There are windows (60a) and (60b) to seal hermetically the nonlinear optical crystal unit (NLU) at the both right and left sides of the through-chamber (42). There are window clamps (70a) and (70b) to fix these windows to the cell body (40). The O-ring (80d) is interposed between the window (60a) and the window clamp (70a). The O-ring (80e) is interposed between the window (60b) and the window clamp (70b). The O-ring (80b) is interposed between the window (60a) and the cell body (40). The O-ring (80c) is interposed between the window (60b) and the cell body (40). The O-ring (80a) is interposed between the cell body (40) and the cell lid (50). The O-rings (80a), (80b), (80c), (80d) and (80e) are resistive to high temperature. These O-rings are made of Kalretz material of DuPont Dow Elastomers Company so that long-life seal can be achieved as the gas emission and gas transmission are very low. The windows (60a) and (60b) arranged in the path of the laser beam are made of synthesized quartz glass or CaF₂ that can endure the high power laser beam. The inside of the unit (NLU) sealed as this is filled with inert gas such as Ar, N₂ and so on. The heater (45) is embedded in the cell body (40) to keep the unit at constant temperature.

Water-repellent coatings (90a) and (90b) are formed on the inner wall of the cell body (40) including the stage (41) and also on the inner wall of the cell lid (50) that covers hermetically the orifice (46) of the cell body (40). The material of these coatings (90a) and (90b) is fluorine plastics. The coatings are deposited on the inner wall of the cell body (40) and cell lid (50) by chemical plating. Teflon (Registered Trademark) can be employed as fluorine plastic material. The method to form the coatings (90a) and (90b) may be other methods than the chemical plating if the coatings (90a) and (90b) can be deposited on the inner wall firmly.

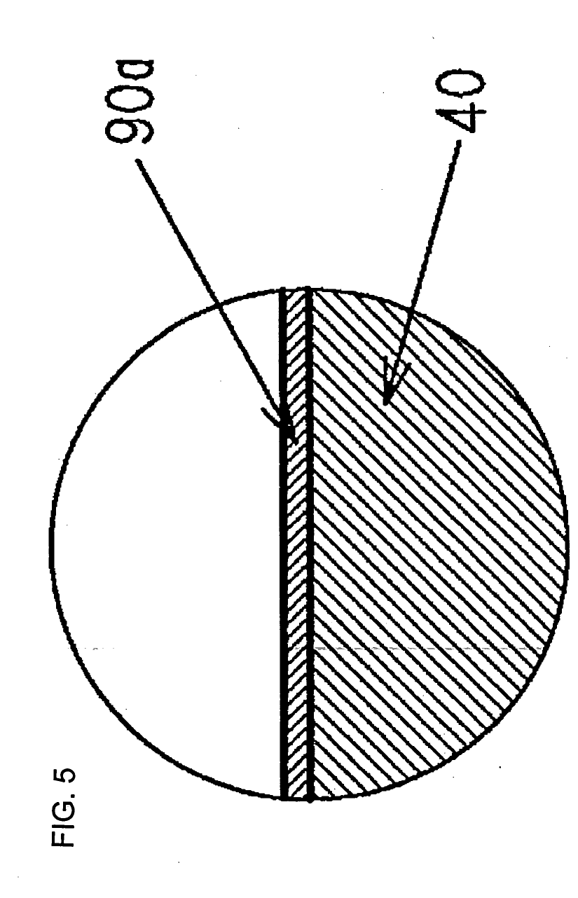

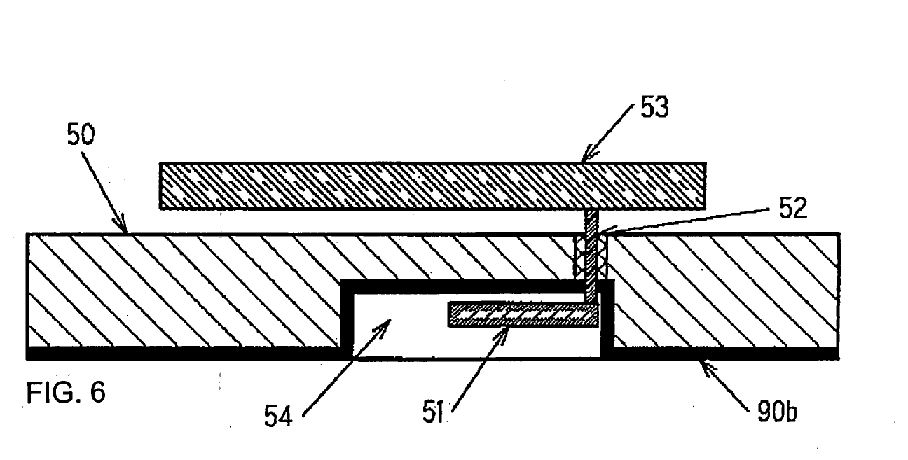

FIG. 5 shows enlarged part A of the nonlinear optical crystal cell as shown in FIG. 4. It shows more precisely the relationship between the inner wall of the cell body (40) and the coating (90a). The cell body (40) and the cell lid (50) are made of metals such as stainless steel (SUS303) and so on. The inner wall is finished by electrolytic polishing if necessary. Some water molecules might adhere to the surface in any case that electrolytic polishing is done or no surface treatment is done. When the inner wall is covered with the water-repellent coating, the water molecules adhere to the surface of the film much less than the molecules on the surface of only electrolytic polishing without water-repellent coating because of its water-repellency. Therefore, the inside of the cell is kept always dry and the nonlinear optical crystal can prevent the absorption of moisture. FIG. 6 shows the schematic cross section of the cell lid.

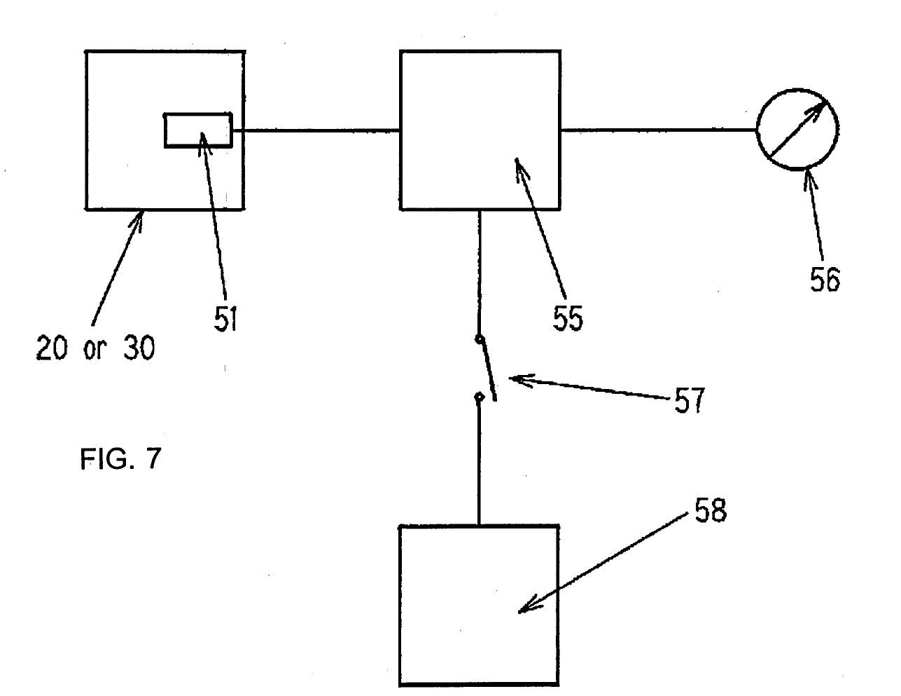

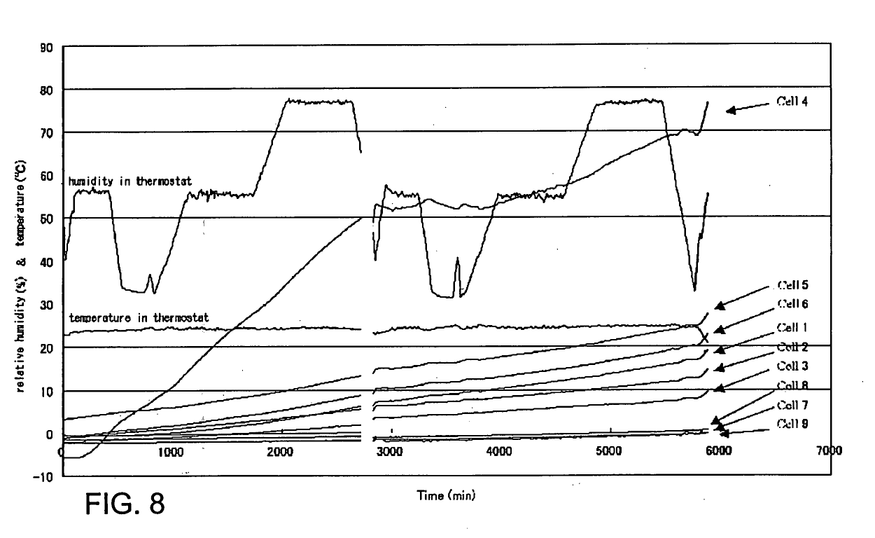

FIG. 7 shows the schematic block diagram of humidity measuring means. The output signal of the humidity sensor (51) in the unit (NLU) is transmitted to the hygrometer (56) through the humidity sensing amplifier (55) on the humidity sensing circuit board (53). The output of the humidity sensing amplifier (55) is transmitted to the laser controller (58) through the switch (57). The humidity sensor (51) employs the humidity sensor element of electric capacity type deposited on the glass substrate in order to enhance the durability and to prevent gas emission out of the sensor element. The humidity sensor element is fixed to the place on the inner side of the lid where the sensor does not intercept the path of the beam in the through-chamber in order to detect the humidity in the through-chamber. The humidity sensor element is connected to the humidity sensing circuit board (53) on the other side of the lid through the hermetic seal terminal (52) in order to insulate electrically from the cell lid (50). FIG. 8 is the graph to show the time trend of the humidity in the cell.

The function of the solid-state laser system according to the embodiment of this invention as constructed above is explained hereinafter. In the solid-state laser system shown in FIG. 1, the fundamental laser wave at wavelength of 1064 nm emitted out of the pumping chamber unit (3) is converged by the first condenser lens (7) and is incident on the first nonlinear optical crystal unit (20) through the window (14). One part of the fundamental laser wave incident on the first nonlinear optical crystal unit (20) is converted into the second harmonic laser wave by the first nonlinear optical crystal unit (20) and exits out of the unit. The fundamental laser wave and the second harmonic laser wave enter the second nonlinear optical crystal unit (30) through the second condenser lens (21) and the exit-window (23). The laser light out of the first wavelength conversion unit (B) is converted into the third harmonic laser wave (three-time fundamental frequency) or to the fourth harmonic laser wave (four-time fundamental frequency) by that nonlinear optical crystal and emerges out of the exit-window (34).

The cell body of the nonlinear optical crystal unit (NLU) constructed as shown in FIG. 4 is made of stainless steel. The changes of the relative humidity in the cell are shown in FIG. 8 in the case of stainless steel without surface treatment, in the case with electrolytic polishing of inner wall of the cell and in the case with deposition of fluorine plastic coating on the inner wall of the cell. Nine cells, each three cells are in one of three surface conditions, are constructed in the vacuum glove compartment with dry nitrogen atmosphere. In a thermostat, environmental relative humidity is varied with constant temperature, the change of the humidity in the cell (measured by the humidity sensor (51) in the cell) are compared. The data showing the relative humidity less than 0% are caused by the error of the signal conversion circuit. Those data are showing the relative humidity of near 0% without limit. In FIG. 8, the transversal axis shows time (t in min), longitudinal axis shows the relative humidity (RH in %) and temperature (T in degree centigrade). Each curve in FIG. 8 is fitted to a line by linear approximation as shown below.
RH=0.00332t-2.8541 (cell 1: without surface treatment)
RH=0.00238t-1.2636 (cell 2: without surface treatment)
RH=0.00188t-2.7552 (cell 3: without surface treatment)
RH=0.01283t-2.4305 (cell 4: with electrolytic polishing)
RH=0.00380t-2.6023 (cell 5: with electrolytic polishing)
RH=0.00374t-1.7302 (cell 6: with electrolytic polishing)
RH=0.00030t-1.7011 (cell 7: with water-repellent surface)
RH=0.00034t-2.5622 (cell 8: with water-repellent surface)
RH=0.00015t-0.3873 (cell 9: with water-repellent surface)

The data of cell 4 are omitted out of comparison data because the rise of humidity is extraordinary. It seems that the hermetic seal is broken according to the defective O-ring (deposit of dust, distortion by unequal closure of lid, etc.). The inclinations of lines showing the rising speed of humidity of other cells are compared. The rising speed of humidity at the cells 7, 8 and 9 (with water-repellent surface) are 0.00030%/min, 0.00034%/min and 0.00015%/min. They are about 1/10 comparing with the other cells. The rise of humidity according to time passing is very slow. For example, cell 7 (with water-repellent surface) can keep relative humidity at most 20% in 50 days. Also, after 73 days, it can keep relative humidity at most 30%. On the other hand, cell 1 (without surface treatment) reaches to relative humidity of 20% in 5 days and cell 5 (with electrolytic polishing) reaches to relative humidity of 20% in 4 days. Also, cell 1 (without surface treatment) reaches to relative humidity of 30% in 7 days and cell 5 (with electrolytic polishing) reaches to relative humidity of 30% in 6 days. According to above result, with water-repellent surface on the inner wall of cell, it is possible to inhibit the absorption of moisture and keep less than 30% of relative humidity in the cell for a long period. Moreover, it is possible to keep relative humidity less than 20%.

The user of the laser system can monitor the humidity in the nonlinear optical crystal unit (NLU) by the hygrometer (56) because that the humidity sensor (51) is equipped in the nonlinear optical crystal unit (NLU). When the humidity changes eventually more than the predetermined value (for example, 30% or 20%), the user can turn the switch (57) off by hand or automatically to stop the laser oscillation. The humidity sensor (51) is not impedimental to the function of the laser system as it is arranged not to intercept the laser path in the medium. The humidity sensor (51) is highly durable as the humidity sensor is electro-capacitor type deposited on the glass substrate. The humidity sensor (51) can be installed in the cell body (40) through the orifice (46) of the cell body (40). Because the humidity sensor (51) and humidity sensing circuit board (53) are mounted on the cell lid (50), the sensor can be fixed easily to adequate position of the unit when the lid is set up. Also the maintenance to inspect these components is easy.

As described above, according that the inner surface of the nonlinear optical crystal cell is covered with water-repellent plastic coating in the embodiment of this invention, the humidity in the cell can be kept in extremely low level. Therefore, the damage caused by the deliquescence of the nonlinear optical crystal can be substantially avoided. The constant efficiency of wavelength conversion can be maintained for a long term. The stabilized power of harmonic laser beam can be obtained.

In this invention, the laser system employing nonlinear optical crystal to generate harmonics of fundamental laser wave out of the laser light source comprises a sealed cell with a through-chamber of the path of the laser wave and a window to cover the through-chamber, wherein the nonlinear optical crystal is disposed in the cell and the inner surface of the cell is treated to be water-repellent. It is clear from the above explanation that the laser system can, as composed above, generate laser beam in a stable state for a long term. The crystal can avoid deliquescence and reduce damages by means of the nonlinear optical crystal being kept in dry atmosphere isolated from outer air by hermetic seal of the nonlinear optical crystal cell.

The quantity of water molecules stuck to the surface of the inner wall can be reduced to minimum extent as the surface of the inner wall of the cell holding the nonlinear optical crystal is covered with water-repellent coating. Therefore, the rise of relative humidity in the cell can be suppressed. The quantity of water molecules leaving from the surface of the inner wall of cell becomes few for a long time. Accordingly, the nonlinear optical crystal can be kept always dry and avoid deliquescence. The laser system and the laser wavelength conversion system can generate laser beam for a long time.

1. A laser system comprising:
a nonlinear optical crystal for generating harmonics of fundamental laser wave out of a laser light source; and
a sealed cell providing with a through-chamber of the path of said laser wave and a window to cover said through-chamber, wherein said nonlinear optical crystal is disposed in said cell and an inner surface of said cell is treated to be water-repellent.

2. The laser system of claim 1, wherein said inner surface of said cell is coated with fluorine plastics to be water-repellent.

3. The laser system of claim 2, wherein said nonlinear optical crystal is made of either one of LBO, KTP, BBO, GdYCOB or CLBO, further comprising a resonator composed of a first mirror and a second mirror, and a solid-state laser material made of either one of Nd:YAG, Nd:YVO₄ or Nd:YLF, wherein said solid-state laser material is interposed between said first mirror and said second mirror.

4. The laser system of claim 3, wherein said cell is disposed either inside of said resonator or outside of said resonator.

5. The laser system of claim 1, wherein inside of said cell is filled with dry inert gas.

6. A laser wavelength conversion system comprising:
a nonlinear optical crystal for generating harmonics of fundamental laser wave out of a laser light source; and
a sealed cell provided with a through-chamber of path of said laser wave and a window to cover said through-chamber,
wherein said nonlinear optical crystal is disposed in said cell and an inner surface of said cell is treated to be water-repellent.

7. The laser wavelength conversion system of claim 6, wherein said inner surface of said cell is coated with fluorine plastics to be water-repellent.

8. The laser wavelength conversion system of claim 7, wherein said nonlinear optical crystal is made of either one of LBO, KTP, BBO, GdYCOB or CLBO.

9. The laser wavelength conversion system of claim 6, wherein the relative humidity in said cell is maintained 30% and under.

10. The laser wavelength conversion system of claim 6, wherein a humidity sensor is equipped in said cell.

11. The laser system of claim 1, wherein said nonlinear optical crystal is made of either one of LBO, KTP, BBO, GdYCOB or CLBO, further comprising a resonator composed of a first mirror and a second mirror, and
a solid-state laser material made of either one of Nd:YAG, Nd:YVO₄ or Nd:YLF, wherein said solid-state laser material is interposed between said first mirror and said second mirror.

12. The laser system of claim 11, wherein said cell is disposed either inside of said resonator or outside of said resonator.

13. The laser wavelength conversion system of claim 6, wherein said nonlinear optical crystal is made of either one of LBO, KTP, BBO, GdYCOB or CLBO.

14. The laser wavelength conversion system of claim 13, wherein the relative humidity in said cell is maintained 30% and under.

15. The laser wavelength conversion system of claim 7, wherein the relative humidity in said cell is maintained 30% and under.

16. The laser wavelength conversion system of claim 8, wherein the relative humidity in said cell is maintained 30% and under.

17. The laser wavelength conversion system of claim 7, wherein a humidity sensor is equipped in said cell.

18. The laser wavelength conversion system of claim 8, wherein a humidity sensor is equipped in said cell.

19. The laser wavelength conversion system of claim 9, wherein a humidity sensor is equipped in said cell.

20. The laser wavelength conversion system of claim 13, wherein a humidity sensor is equipped in said cell.

21. The laser wavelength conversion system of claim 14, wherein a humidity sensor is equipped in said cell.

22. The laser wavelength conversion system of claim 15, wherein a humidity sensor is equipped in said cell.

23. The laser wavelength conversion system of claim 16, wherein a humidity sensor is equipped in said cell.
